(19) United States
(12) Patent Application Publication
(10) Pub. No.: US 2023/0397039 A1
(43) Pub. Date: Dec. 7, 2023

(54) Combining User and Operator Intents in Network Slice Design

(71) Applicants: Maria TOEROE, Montreal (CA); Nour GRITLI, Montreal (CA); Ferhat KHENDEK, Montreal (CA); TELEFONAKTIEBOLAGET LM ERICSSON (PUBL), Stockholm (SE)

(72) Inventors: Maria Toeroe, Montreal (CA); Nour Gritli, Montreal (CA); Ferhat Khendek, Montreal (CA)

(73) Assignee: TELEFONAKTIEBOLAGET LM ERICSSON (PUBL), Stockholm (SE)

(21) Appl. No.: 18/033,275

(22) PCT Filed: Nov. 24, 2020
(86) PCT No.: PCT/IB2020/061101

§ 371 Date: Apr. 21, 2023

(51) Int. Cl. H04W 28/02; H04L 47/20; H04L 41/14; H04L 41/0806

(52) U.S. Cl. CPC H04W 28/0268; H04L 47/20; H04L 41/145; H04L 41/0806

(57) ABSTRACT

The disclosure relates to a method, apparatus and computer readable media for combining user and operator intents in network slice design and deployment. The method comprises receiving user intents for requested functionalities. The method comprises generating a solution map in which a network slice design is created for each requested functionality, each network slice design being associated with a plurality of operator policies that satisfy the user intents. The method comprises comparing the operator policies associated with the network slice designs for the requested functionalities and combining the network slice designs with matching operator policies into one or more merged network slice design if the user and operator intents are satisfied and if no isolation requirement is violated. The method comprises deploying, in a network of the operator, one or more merged network slice based on the one or more merged network slice design.

### TECHNICAL FIELD

The present disclosure relates to the field of cloud systems management and network slice design and deployment.

### BACKGROUND

Network slicing enables the provisioning of multiple logical networks, i.e. network slices (NwSs), on top of a common physical infrastructure. These NwSs are customized to meet specific functional requirements (e.g. security functions, handover management and mobility management functions) as well as non-functional requirements such as performance, Quality of Service (QoS) and isolation. The provisioning of a NwS may be triggered upon the request of one or multiple communication services (CSs) or as a transport slice also known as “NwS as a Service” (NSaaS).

The main motivation behind network slicing is the capability of supporting CSs with different performance requirements simultaneously in the same physical infrastructure. For example, in Third Generation Partnership Project (3GPP) standards, three main service categories or slice types were defined based on their performance requirements, i.e. enhanced Mobile Broad Band (eMBB), Ultra-Reliable and Low-Latency Communications (URLLC), massive Machine Type Communications (mMTC). The eMBB services are characterized with high data rates and traffic capacities. The URLLC services require very low latency and high reliability. The mMTC services need to support a high density of IoT devices, while maintaining cost efficiency. In 3GPP, target performance requirements were given for some use cases. For instance, a high data rate service with a user density of 100/km2 in a rural macro scenario requires 50 Mbps of data rate downlink (DL).

The management of a NwS is performed by three functional blocks. The Communication Service Management Function (CSMF) is in charge of translating a CS into NwS requirements as well as interacting with the Network Slice Management Function (NSMF). The main role of the NSMF is the lifecycle management of the NwS, and accordingly, determining the network slice subnets related requirements and passing them to the Network Slice Subnet Management Function (NSSMF). The latter is responsible for the lifecycle management of NwS subnets.

3GPP defines four phases for the lifecycle management of a NwS instance. Before an NwS can be instantiated it needs to be designed as part of the preparation phase. This includes the evaluation of the NwS requirements, the creation and on-boarding of the network slice template (NST). The NST includes a complete description of the structure, configuration and workflows for the NwS instantiation and its life cycle management. The commissioning phase involves the instantiation and the configuration of the NwS resources. The third lifecycle management phase is the operation of the NwS instance, in which the NwS instance can be activated, deactivated, or modified. The final phase is the decommissioning of the NwS instance, when it is deactivated and its resources are deallocated (reclaimed).

The introduction of multiple NwSs with different performance and functional requirements to telecommunication networks, in combination with the possibility of spanning multiple operators' domains, raises the complexity of network management which needs to ensure the required performance. Therefore, efforts were put in place to automate and reduce the complexity of management of these networks. In this context, concepts like zero touch networks and intent-based networking are being developed to achieve this automation. For instance, 3GPP introduces the concept of intent driven Management Service (MnS) for mobile networks. The goal of this intent driven MnS is to reduce the complexity of management, by allowing to express intents for managing the network and its services without knowing the details of the underlying infrastructure. The intent driven MnS is then responsible for translating the intents into executable actions. Multiple scenarios are provided in this context, such as CS deployment at the edge, network provisioning, etc. In the network provisioning scenario, for example, a consumer should be capable of expressing their intent by providing high level requirements, for example, that they would like an eMBB NwS which provides 50 Mbps in the DL data rate for a maximum number of UEs. The intent driven MnS needs to translate this intent into deployment related requirements, such as resources, placement, configuration.

### SUMMARY

Current efforts in the area of intent-based management and networks automation focus on run-time phases of the NwS lifecycle management (commissioning, operation and decommissioning). The intent-based design of NwSs of the preparation phase is not addressed yet. Instead pre-defined NSTs are being used. Since consumer requirements and needs can vary widely from both functional and non-functional perspective, they may not always have a direct translation to a pre-defined or to existing NSTs.

In addition, the design of a NwS is a complex task, during which different requirements need to be analyzed and translated to deployment templates/descriptors. Depending on its QoS requirements, a CS may or may not fit into one of the pre-defined service categories. For instance, some CSs may have custom performance requirements such as ultra-low latency, high bandwidth and high reliability at the same time. Besides, the customer/user requirements or intents operators may have intents/requirements on their own, all of which should be considered together in the design.

Finally, NwSs and/or CSs may be combined for optimization purposes or may need to be kept separate for performance or administrative reasons. This aspect is usually considered at the commissioning phase, but it impacts also the design, which is not addressed at all.

There is provided a method for combining user and operator intents in network slice design and deployment. The method comprises receiving user intents for a plurality of requested functionalities. The method comprises generating a solution map in which a network slice design is created for each one of the plurality of requested functionalities, each network slice design being associated with a plurality of operator policies that satisfy the user intents. The method comprises comparing the operator policies associated with the plurality of network slice designs for the plurality of requested functionalities and combining the network slice designs with matching operator policies into one or more merged network slice design if the user and operator intents are satisfied and if no isolation requirement is violated for the one or more merged network slice design. The method comprises deploying, in a network of the operator, one or more merged network slice based on the one or more merged network slice design.

There is provided an apparatus operative to combine user and operator intents in network slice design and deployment comprising processing circuits and a memory. The memory contains instructions executable by the processing circuits whereby the apparatus is operative to receive user intents for a plurality of requested functionalities. The apparatus is operative to generate a solution map in which a network slice design is created for each one of the plurality of requested functionalities, each network slice design being associated with a plurality of operator policies that satisfy the user intents. The apparatus is operative to compare the operator policies associated with the plurality of network slice designs for the plurality of requested functionalities and combine the network slice designs with matching operator policies into one or more merged network slice design if the user and operator intents are satisfied and if no isolation requirement is violated for the one or more merged network slice design. The apparatus is operative to deploy, in a network of the operator, one or more merged network slice based on the one or more merged network slice design.

There is provided a non-transitory computer readable media having stored thereon instructions for combining user and operator intents in network slice design and deployment. The instructions comprise receiving user intents for a plurality of requested functionalities. The instructions comprise generating a solution map in which a network slice design is created for each one of the plurality of requested functionalities, each network slice design being associated with a plurality of operator policies that satisfy the user intents. The instructions comprise comparing the operator policies associated with the plurality of network slice designs for the plurality of requested functionalities and combining the network slice designs with matching operator policies into one or more merged network slice design if the user and operator intents are satisfied and if no isolation requirement is violated for the one or more merged network slice design. The instructions comprise deploying, in a network of the operator, one or more merged network slice based on the one or more merged network slice design.

The method and apparatus and non-transitory computer readable media provided herein present improvements to the way network slice design and deployment operate. The method allows for the definition of custom slice types in addition to the ones defined in 3GPP. The description of the operator intents is not tied to a set of 3GPP use cases. Instead, it is defined from a QoS perspective. Hence, the method can support intents for new CSs or NwSs. Also, the proposed method already at design time takes into account grouping and placement constraints, which allow for solutions that are not considered today. In addition, the solution combines the user and operator intents in a consistent way to support any further processing and the deployment of the NwS instances.

### BRIEF DESCRIPTION OF THE DRAWINGS

FIG. 1 is a schematic illustration of a NSliceReq Metamodel.

FIG. 2 is a schematic illustration of an example NSliceReq Model.

FIG. 3 is a schematic illustration of a Grouping Policies Metamodel.

FIG. 4 is a schematic illustration of an example Operator Intent Model.

FIG. 5 is a schematic illustration of a Solution Map Metamodel.

FIG. 6 is a flowchart of a method for matching the QoS Intents to the Grouping Policies.

FIG. 7 is a schematic illustration of an example of how the flowchart of FIG. 6 is applied.

FIG. 8 is a flowchart of a method for merging NwSs based on their matched policies.

FIG. 9 is a schematic illustration of an example of how the flowchart of FIG. 8 is applied.

FIG. 10 is a schematic illustration of an example of a generated SM without merged NwSlices.

FIG. 11 is a schematic illustration of an example of a generated SM with merged NwSlices.

FIG. 12 is a schematic illustration of a virtualization environment in which the different method(s) and apparatus(es) described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

The below description addresses intent based NwS design. The method considers a user intent for one or multiple CSs and NwSs along with their desired QoS characteristics as input. It also takes into account the operator's intents which defines the slice types that the operator is able to support with their QoS characteristics. From these inputs, the proposed method generates a set of solutions each of which specifies a number of NSTs necessary to support the CSs and the NwSs requested by the user, and which is in compliance with the operator's intents. To ensure this compliance in any further processing and deployment, the proposed method complements the generated solution to the user intents with any missing QoS requirements derived from the operator intents.

In the context of intent based NwS design, a user can express their intent at a high-level without knowing the details of the operator's networks, i.e. the different slice types that can be supported or the ranges of QoS that can be guaranteed. For instance, a user describing their intent as two CSs with QoS may not be aware of the NwS types that can support these CSs and their characteristics. The user may also not provide all the QoS parameters in the intent that are necessary to characterize a NwS or a CS for the operator. Hence, it is the operator's task to complete the list of QoS based on the slice type selected for the design. Taking into consideration all of these, a method is proposed that combines user intents with operator intents in a consistent manner so that the NwSs designed as a result for deployment satisfy both intents. The method expects two inputs, namely the user intent (NSliceReq) and the operator intent (i.e. Grouping Policies). Given the QoS parameters of the NSliceReq intent, the method selects the grouping policies that can guarantee the NSliceReq intent. Based on the selection, the method is able to decide on the number of NwSs to design. The details of the method are described below, starting with a description of the Metamodels.

Starting with the User Intent, the NSliceReq Metamodel is described. The network slice requirements (NSliceReq) metamodel allows a user to express their intent for CSs and/or transport NwSs. The user providing an NSliceReq model (i.e. an instance of the NSliceReq metamodel) does not need to be aware of the details of the intended NwSs and/or CSs and their provisioning. Hence, a NSliceReq expresses a high-level intent for the NwSs and CSs requested with attributes appropriate for such an abstraction (e.g. QoS, isolation requirements, etc.).

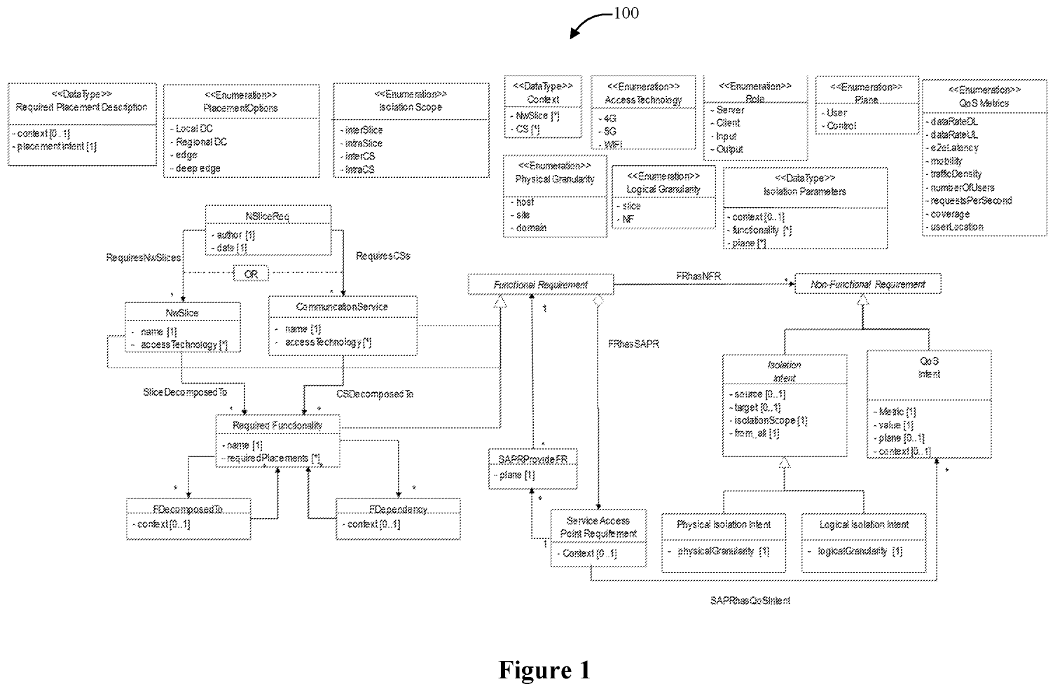

The NSliceReq metamodel 100 is shown in FIG. 1. An NSliceReq model (instance) may consist of one or multiple instances of the CommunicationService and/or NwSlice elements. Each instance of the NwSlice element and CommunicationService element is identified by a name and may have an accessTechnology attribute. For instance, a user may require a 5G NwS and a VoLTE CS.

For a CS represented by a CommunicationService element a specific decomposition may be requested, which can be expressed using CsDecomposedTo associations to functionalities described by instances of the Required Functionality element. A functional decomposition can also be described for a NwS represented by a NwSlice element using the SliceDecomposedTo association. In a similar manner, instances of the Required Functionality element can be used to specify further functional decompositions of a functionality through the FDecomposedTo associations.

An intent for dependencies between instances of the Required Functionality element can also be expressed using the FDependency association.

The Required Functionality element allows the specification of placements for its instances through a requiredPlacement attribute, which may be limited only to a given context. To request a specific placement for a functionality, an instance of the Required Placement Description element can be used, which includes two attributes: a placement intent (with possible values of edge, deep edge, regional DC, local DC) and a context within which the placement is applicable (i.e. Nw slice or CS). When no context is specified, the required placement is considered for any NwS or any CS which has a decomposition relation with the functionality described by the given instance of the Required Functionality.

Instances of the NwSlice, the CommunicationService and the Required Functionality elements specify Functional Requirements (FRs) of the NSliceReq intent and they can be associated with non-functional requirements (NFRs) using instances of the Isolation Intent, the QoS Intent, and the Service Access Point Requirement (SAPR) elements.

Isolation requirements may need to be described between NwSs, between CSs, and/or between functionalities of the same or different NwSs/CSs. To be able to express such isolation requirements four isolation scopes are defined.
Inter-slice: isolation requirements with this scope express non-sharing of physical and/or logical resources between NwSs (instances from the same NST and/or from different NSTs).
Intra-slice: isolation requirements with this scope express non-sharing of physical and/or logical resources within the same NwS.
Inter-CS: isolation requirements with this scope express non-sharing of physical and/or logical resources between the CSs.
Intra-CS: isolation requirements with this scope express non-sharing of physical and/or logical resources between functionalities of a given CS.

An instance of the Isolation Intent element is used to specify an isolation requirement with an isolationScope with one of the above values and whether full or partial isolation is required. For full isolation, the attribute from_all is set to true and the source attribute can be used to characterize further the isolation (e.g. plane). For partial isolation, the from_all attribute is set to false and the target attribute specifies the applicability of the isolation. The source and the target attributes are of type Isolation Parameters, and specify the context of the isolation, the functionalities (which could be NwSlices, CommunicationServices, and/or Required Functionalities) to be isolated from (specified only in the target) and the plane. The instances of the Isolation Intent elements are used to express both physical and logical isolation requirements at different granularities. They can be associated with FRs of any level. For the physical granularities an enumeration is defined with values of host, site and domain. Similarly, the logical granularities are defined with values slice or Network Function (NF).

Instances of the QoS Intent element are used to specify the QoS requirements for a NwS, a CS and/or a functionality. A QoS requirement (or QoS intent) is defined with a metric (values of QoS Metrics enumeration e.g. dataRateDL, numberOfUsers), a value, a plane and optionally a context. A QoS requirement can be attached to an FR directly or through a service access point requirement (SAPR).

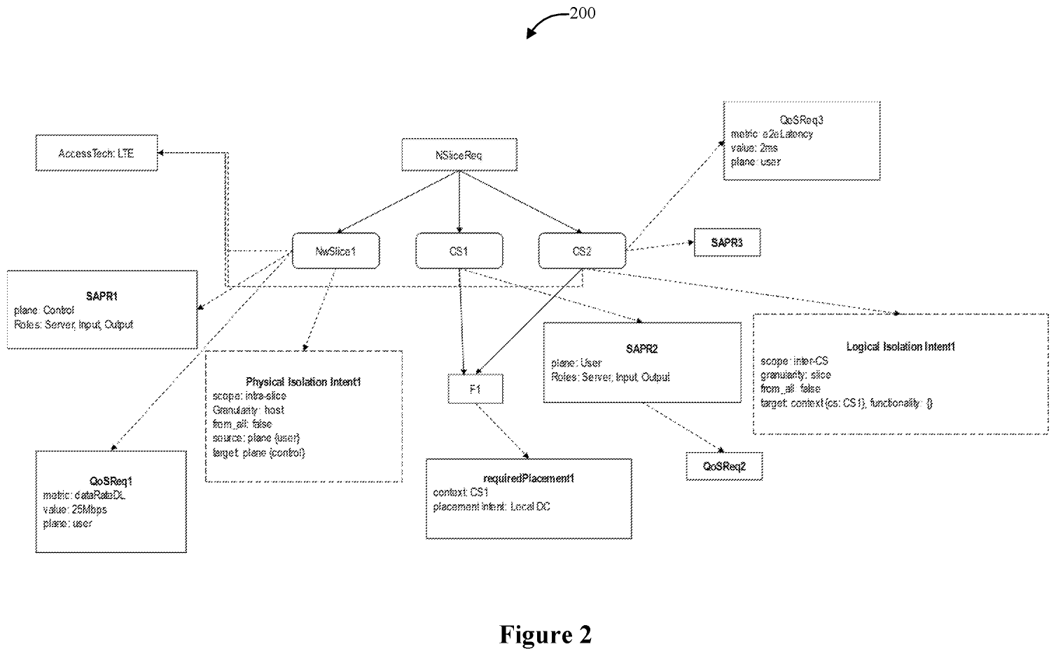

FIG. 2 shows an example of a NSliceReq 200, in which a user requests a NwS (NwSlice1), and two CSs (CS1 and CS2). For all of them the same access technology (LTE) is requested. Each of these FRs is associated with a SAPR and a QoS intent. In addition, NwSlice1 has a physical isolation requirement defined between its control plane and user plane functionalities. CS2 has a logical isolation requirement specifying that CS2 cannot be supported by the same NwS as CS1. In this example, CS1 and CS2 both specify in their decomposition functionality F1, which in the context of CS1 also has a placement requirement.

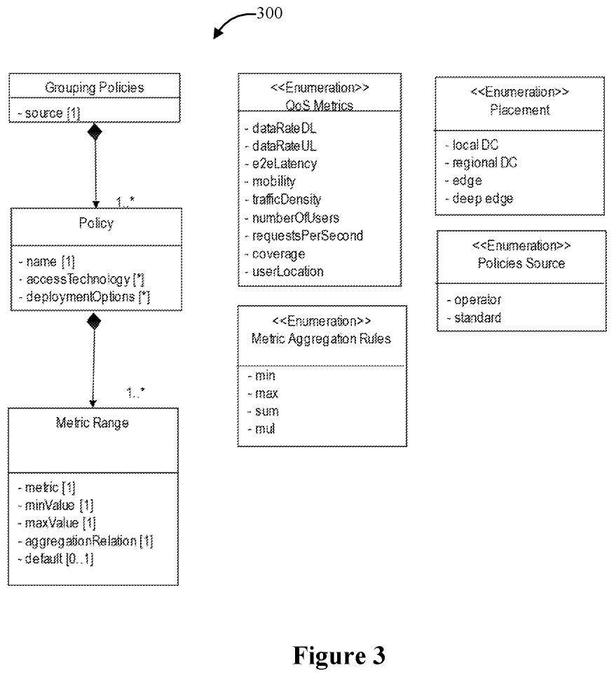

Next, Operator Intent, and Grouping Policies Metamodel 300 is described in relation with FIG. 3. The Grouping Policies Metamodel 300 is defined to represent the intent of network operators. Instances of the Grouping Policies specify the supported by the operator QoS characteristics for NwSs. A grouping policies model specifies a set of policies as instances of the Policy element. Each policy comprises one or multiple instances of the Metric Range element. A policy may be defined for specific access technologies in the accessTechnology attribute. It may also include deployment options (deploymentOptions attribute) necessary to achieve the QoS ranges. An instance of the Metric Range element specifies a metric and a range given as the minimum and maximum values supported by the corresponding policy. For each Metric Range, an aggregation relation needs to be specified so that the aggregated QoS value can be calculated for the metric. Using a Grouping Policies model, an operator can define policies with standard and/or custom QoS ranges. The Grouping Policies need to cover the entire spectrum of supported NwSs to ensure that they can be properly matched with user intents, i.e. any valid user intent can be matched to at least one policy. However, it is not necessary to fully specify each policy within the Grouping Policies.

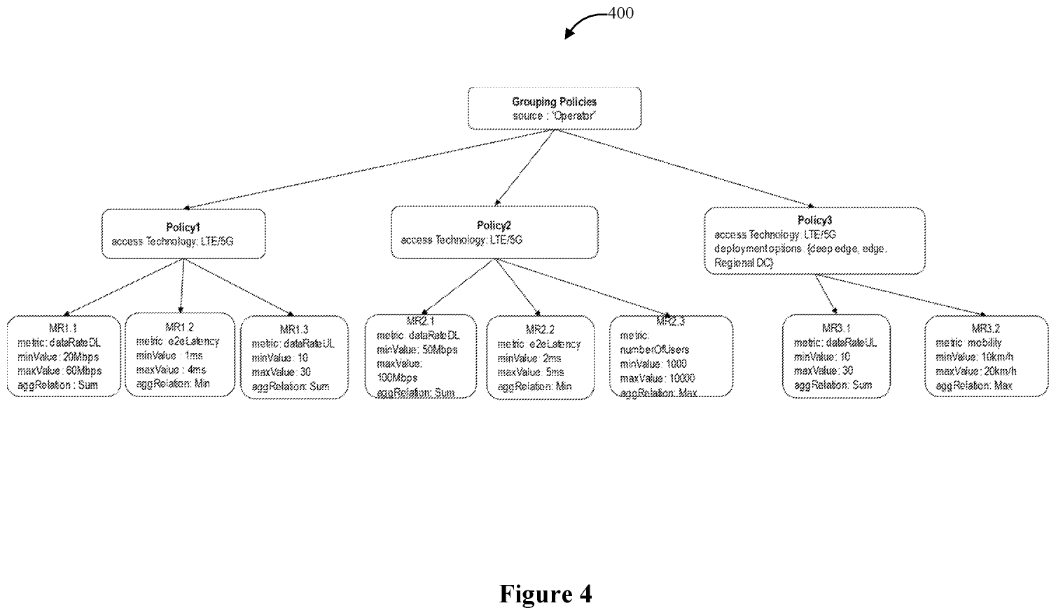

FIG. 4 shows an example Grouping Policies model 400. In this example, three policies have been defined Policy1, Policy2 and Policy3, all for the same access technology (LTE/5G). Policy1 and Policy2 do not specify any deployment option, while Policy3 defines the deep edge, edge and Regional DC deployment options necessary to achieve its QoS ranges.

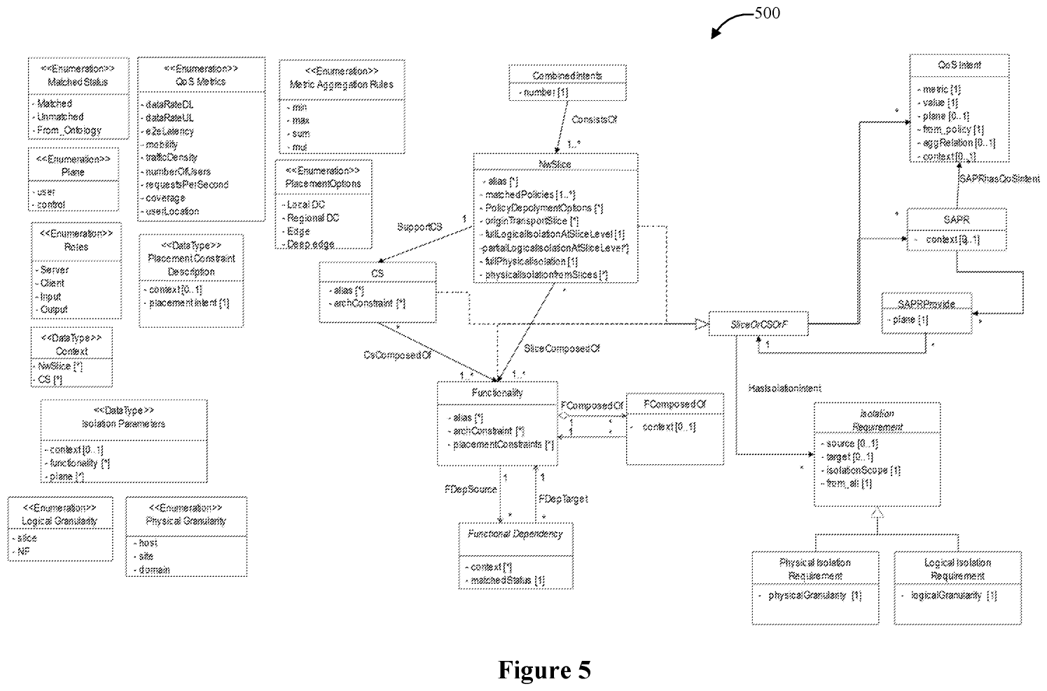

The Solution Map Metamodel 500 is described in relation with FIG. 5. The solution map (SM) metamodel aggregates the results of the NwS design process step by step. Each SM model represents a possible solution satisfying a given NSliceReq intent of a user according to the operator's Grouping Policies.

According to this SM metamodel, a NwSlice may support zero to many CSs. A NwSlice or a CS may be composed of functionalities. In turn, these functionalities may be composed of other functionalities and/or may depend on other functionalities similar to what was described for the NSliceReq metamodel. Accordingly, elements on the SM metamodel are the same as of the NSliceReq metamodel. More details and example SM models will be presented as part of the description of the method.

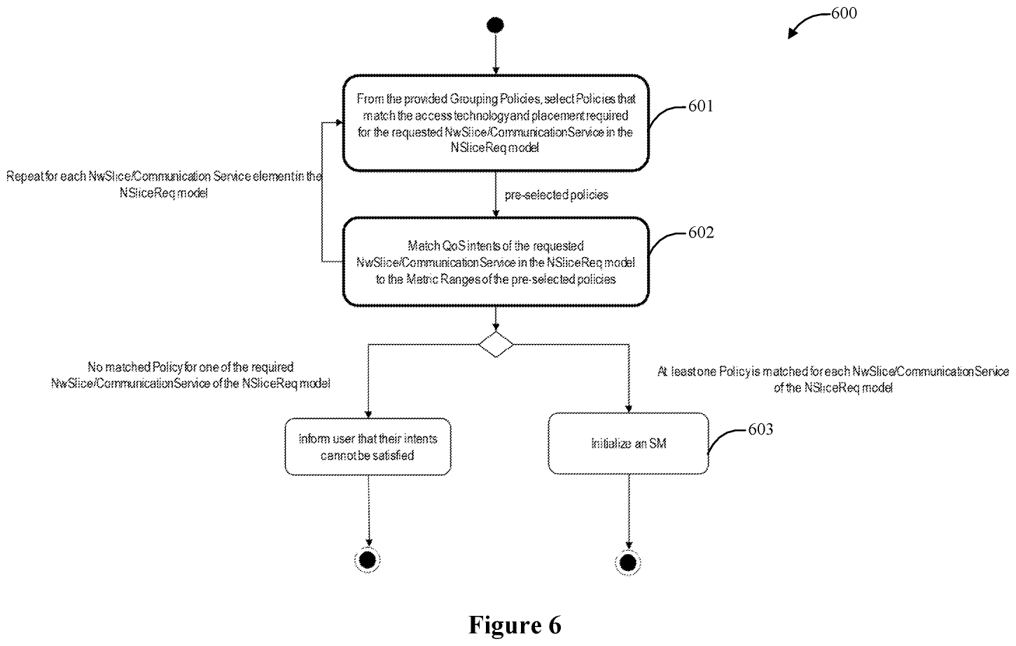

The proposed method consists of two main steps: matching of QoS intents to the Grouping Policies; and merging of NwSs based on their matched Policies. Reference is now made to FIG. 6, which illustrates the step, 600, of matching the QoS Intents to the Grouping Policies. The goal of this part is to check if the QoS Intents requested by the user can be supported by the network operator.

As described previously, a user may give a NSliceReq intent by specifying the FRs in terms of CommunicationServices and/or NwSlices, which in turn can be associated with NFRs expressed as QoS Intents. To determine if the requested FRs and NFRs can be supported, the NSliceReq is matched to the network operators' Grouping Policies. In this matching procedure, a subset of requirements from the NSliceReq intent are considered. Namely, the requirements specifying the QoS intents, the access technology and the placement requirements of the requested NwSlices and CommunicationServices. FIG. 6 shows the flowchart of this step.

The process is repeated for each NwSlice/CommunicationService requested in the NSliceReq.

First, from the Grouping Policies the policies are selected which support the required access technology and placements of the NwSlice/CommunicationService, step 601. Then, the QoS Intents of the NwSlice/CommunicationService are compared with metric ranges of the selected policies, step 602. For each requested NwSlice/CommunicationService with matched policies an SM is generated, step 603.

To select the matching policies, first, for each requested NwSlice/CommunicationService of the NSliceReq, the required placement and access technology (AT) are compared with the policies of the operator's Grouping Policies to select those policies for which the same AT is specified as the required AT, and which also include the required placement among their deployment options. If a policy does not specify any AT and/or deployment option(s), it is selected as well, since it allows for any option, therefore, it does not contradict to the user intent.

Next, the QoS intents of the requested NwSlice/CommunicationService is compared against the metric ranges of each policy selected. If any requested QoS intent metric of the NwSlice/CommunicationService is out of range for the range specified in the policy, this policy is removed from the set of selected policies as the policy does not support the requested QoS intent.

It is possible that for a requested QoS intent metric no range is defined in a policy. As long as the other requested QoS intent metrics are within range for the policy, the policy is kept in the selected policies set.

It is also possible that more than one policy matches the QoS Intents of a requested NwSlice/CommunicationService. In this case, all these policies are considered for the solution.

If the QoS Intents of a requested NwSlice/CommunicationService do not match any policy, i.e. they are out of range for all policies, that means that the network operator is not able to provide the requested NwSlice/CommunicationService. Hence, the NSliceReq intent cannot be satisfied, no solution will be generated, and the process stops. For this reason, the Grouping Policies should cover the complete range of supported NwSs.

If at least one matching policy has been found for each requested NwSlice/CommunicationService of the NSliceReq, an SM is initialized for it.

To initialize the SM, from a NwSlice/CommunicationService element of the NSliceReq a NwSlice/CS element is created in the SM, which is a copy of the NwSlice/CommunicationService element of the NSliceReq.

For a NwSlice element created in the SM the MatchedPolicies attribute is set according to the results of the policies matching.

For a CS element created in the SM, the process starts by considering a separate supporting NwSlice for each requested CS. Hence, in addition to the created CS a NwSlice element is also created in the SM with a Support association between this NwSlice element and the CS it supports. Then the MatchedPolicies attribute of this supporting NwSlice element is set according to the results of the policies matching for the CommunicationService for which the CS element was created, i.e. the CS the NwSlice supports.

This is done because two types of NwSlices are designed, transport slices, for which the FRs and NFRs are specified explicitly; and NwSlices for which the FRs and NFRs are implied from the requested CommunicationServices since they need to support these CommunicationServices.

Next, the Required Functionalities of the NSliceReq model are transformed into Functionality elements of the SM model. Any SliceDecomposedTo/CSDecomposedTo/FDecomposedTo association in the NSliceReq model is transformed respectively into a sliceComposedOf/csComposedOf/fComposedOf association of the SM model. If a context is defined for the decomposition in the NSliceReq, it is copied to the SM model.

Handling of Logical Isolation Intents is now explained. For each requested NwSlice of the NSliceReq model, it is checked whether it has a partial or full logical isolation requirement with the scope “inter-slice” and granularity “slice”.

The from_all attribute of a NwSlice set to true means full logical isolation and the instance(s) of the requested NwSlice cannot be shared with any NwS in the system (deployed or to be deployed and related or unrelated to the NwSlice). Hence, the fullLogicalIsolationAtSliceLevel attribute of the NwSlice element of the SM is set to true.

If the from_all attribute is set to false, the partialLogicalIsolationAtSliceLevel attribute needs to be set. For this, the target attribute of the logical isolation intent associated with the NwSlice in the NSliceReq identifies in its context attribute the slices that cannot have any sharing relation with this NwSlice. The context attribute may specify NwSlices and/or Communication Service elements.

For each NwSlice element of the NSliceReq specified in the context, the corresponding NwSlice element of the SM is added to the partialLogicalIsolationAtSliceLevel attribute.

If the context specifies a CommunicationService in the NSliceReq, this relation is transferred to the slice level. Therefore, the NwSlice element supporting the CS of the SM corresponding to the CommunicationService in the NSliceReq is added to the partialLogicalIsolationAtSliceLevel attribute.

Since the goal is to design NwSs, logical isolation intents requested for communication services need to be transferred to the slice level. Accordingly, for a CommunicationService of the NSliceReq model, the logical isolation intent with the scope of “inter-CS” and granularity of “slice” is transformed as follows.

If the from all is set to false, the intent means that the CommunicationService cannot be supported by a NwSlice supporting other CommunicationServices, which are specified in the context of the target attribute. Accordingly, the NwSlices of the SM are added to the partialLogicalIsolationAtSliceLevel attribute of the NwSlice supporting the CS (in the SM) corresponding to the requested CommunicationService (in the NSliceReq), which support the CSs of the SM corresponding to the CommunicationServices specified in the context of the target attribute of the NSliceReq model.

When the logical isolation intent has the from_all attribute set true, this implies that NwSlice of the SM supporting the CS corresponding to the requested CommunicationService should be fully isolated. Therefore, the fullLogicalIsolationAtSliceLevel attribute of this NwSlice is set to true in the SM model.

The rest of logical isolation intents are copied as-is from the NSliceReq to the SM.

Handling of Physical Isolation Intents is now described. A requested NwSlice/CommunicationService in the NSliceReq model may have full or partial physical isolation intents associated. These are reflected in the fullPhysicalIsolation and the physicalIsolationFromSlices attributes of the appropriate NwSlice elements in the SM.

If a requested NwSlice/Communication Service element has a physical isolation intent with the “inter-slice” scope and the from all attribute set to true, this intent implies that the requested NwSlice or the NwSlice supporting the requested Communication Service should have full physical isolation. Hence, the fullPhysicalIsolation attribute of the corresponding NwSlice (requested or supporting the requested CS) in the SM model is set to true.

If a requested NwSlice/Communication Service element has a physical isolation intent with the “inter-slice” scope, the from_all attribute set to false and a target attribute defined with a context referencing a set of NwSlices/Communication Services without specifying any functionality, the requested NwSlice or the NwSlice supporting the requested Communication Service has to be physically isolated from the referenced NwSlices directly listed and NwSlices supporting the Communication Services listed in the target attribute. Accordingly, the attribute physicalIsolationFromSlices is populated with the corresponding NwSlices created in the SM model.

All physical isolation intents of the NSliceReq (including the ones discussed) are copied to the SM for further processing.

Finally, the SAPRs and QoS intents with their associations are copied as-is from the NSliceReq model to the SM model.

To illustrate the first step, let us consider the example of NSliceReq and Grouping Policies shown respectively in FIG. 2 and FIG. 4. In this example, the user requests one NwSlice (NwSlice1) and two CommunicationServices (CS1 and CS2) with their respective QoS intents and the AccessTech LTE as shown in FIG. 2. First the AT is checked against the policies shown in FIG. 4. All the provided policies are applicable to the 5G/LTE AT, hence they are all considered further for the requested NwSlice and CommunicationServices.

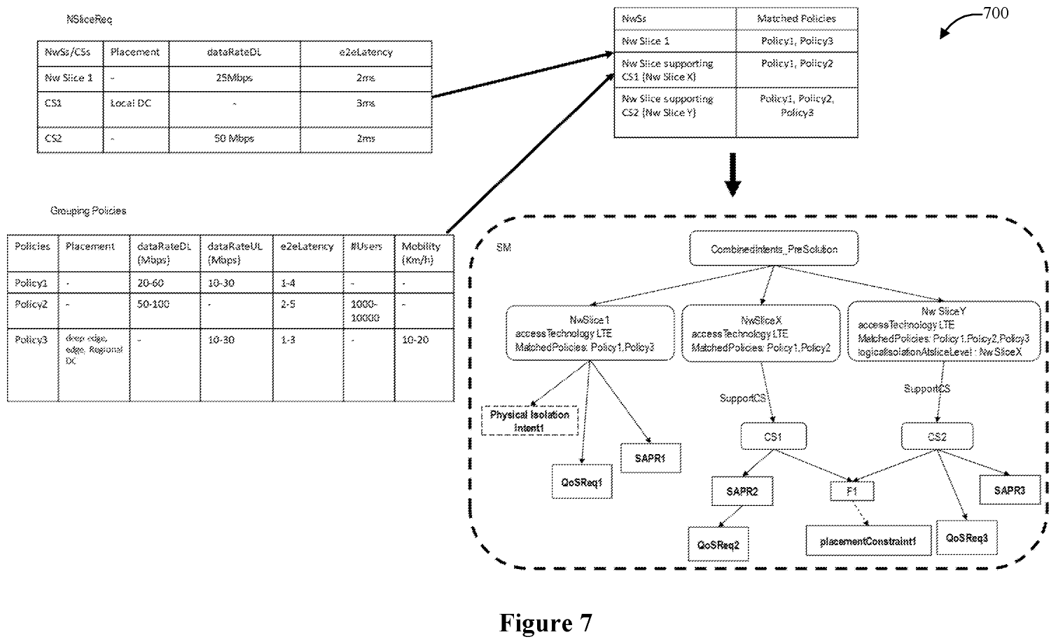

Next, the placements required by the NSliceReq model are checked against deployment options defined in the selected Policy elements. Policy1 and Policy2 do not specify deployment options, hence they remain in the selection for all: NwSlice1, CS1 and CS2. In contrast, Policy3 defines {deep edge, edge, regional DC} as deployment options. Since CS1 requires for its required functionality F1 a “Local DC” placement Policy3 cannot satisfy this and is removed from the selection for CS1. Policy3 remains in the selection only for NwSlice1 and CS2. Next, the QoS intents of each requested element is compared with the policies selected for them if they are in range, which is the case for our example. FIG. 7 shows an example result 700 of policy matching for the requested NwSlice and CommunicationServices. Given this result, an SM is generated as shown in FIG. 7. The CommunicationServices requested in the NSliceReq model are copied to the SM as CS elements and for each of them a NwSlice element is created with a SupportCS association (i.e. NwSliceX supports CS1 and NwSliceY supports CS2). NwSlice1 is copied as-is to the SM model. The matched policies attribute of each NwSlice in the SM is set according to the results of the policy matching.

After that the isolation intents are handled. In this example, CS2 requires a logical isolation from CS1 at the slice granularity and the scope of “inter-slice”. Therefore, the logicalIsolationAtSliceLevel attribute of NwSliceY is set to reference NwSliceX in the SM.

The rest of the elements are copied from the NSliceReq to the SM as is.

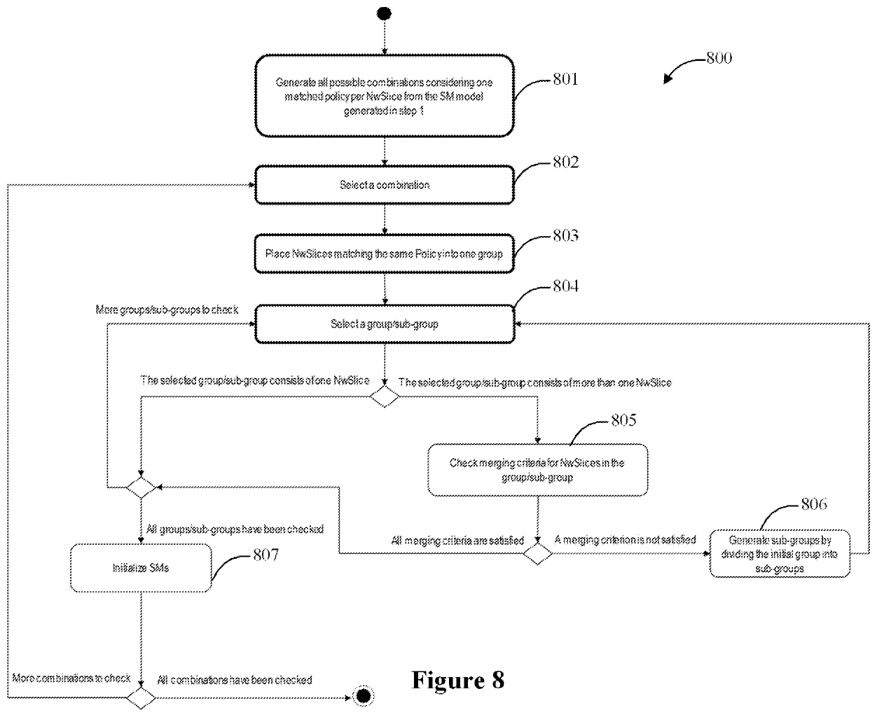

Turning to FIG. 8, the merging of NwSs based on their matched Policies, step 800, will now be described.

As described above, the SM resulting from the workflow of FIG. 6 is comprised of NwSlice elements with their matched policies and isolation attributes, which may support at most one CS at this point. To determine if any of the NwSlices can be merged with another, their matched policies attributes are checked, i.e. whether they match the same policy.

At step 801, all possible combinations of NwSlices are generated where each NwSlice is matched with exactly one policy. For instance, if NwS1 matches Policy1 and Policy2, and NwS2 matches Policy1, two combinations are generated.
Comb1: {NwS1 matching Policy1, NwS2 matching Policy1}
Comb2: {NwS1 matching Policy2, NwS2 matching Policy1}

NwSlices matched to different policies cannot be merged within a combination. In a combination where a subset of NwSlices are matched to the same policy (e.g. Comb1) this subset of NwSlices have the potential of merging and are placed in a group (e.g. Comb1: {group1: {NwS1 matching Policy1, NwS2 matching Policy1}}), steps 802 and 803. To perform the merging, three criteria need to be fulfilled as discussed below. If at any point during the processing a state is reached that no merging is possible, i.e. each NwSlice is matched to a different policy or placed into a group of its own, no further processing is needed. Otherwise the next criterion is checked until all three criteria were processed.

Isolation intent criterion: NwSlices matched to the same policy and forming a group are checked with respect to their attributes of logical and physical isolations that were initialized in the workflow of FIG. 6. Those NwSlices requiring full logical/physical isolation cannot be merged with any other NwSlice, while those requiring partial logical/physical isolation cannot be merged with the NwSlices indicated in their respective attribute. If there are NwSlices in the group that cannot be merged, the group is split into sub-groups containing NwSlices that could be merged without violating their isolation intents, steps 804, 805 and 806. For instance, let us assume that NwS1 requires full logical isolation and cannot be merged with NwS2.

As a result, within Comb1 two sub-groups are created from the previous group1: Comb1: {group1.1: {NwS1 matching Policy1}, group1.2: {NwS2 matching Policy1}}. In this example the processing of criteria would stop as each NwSlice is in a group of its own for Comb1, while in Comb2 each NwSlice matched to a different policy.

A Placement intent criterion is checked, step 805, only if two or more NwSlices in a group have a common Functionality element. If this Functionality has different placement constraints for the different NwSlices, these NwSlices cannot be merged as they would result in contradicting placement constraints for the common Functionality. Again, such groups are divided further into sub-groups to avoid such conflicts, step 806.

At this point, the NwSlices remaining in the same group could be merged without the violation of any placement constraints. Policy constraints on QoS aggregates are then checked, step 805, i.e. it is checked if their combined QoS requirements would result in policy violation. I.e. if their combined QoS requirements are permitted by the metric ranges defined for the matched policy. To check, for each metric range of the matched policy the respective QoS requirements of all NwSlices in the group are aggregated using the aggregation relation specified by the policy for the metric (e.g. summation, min, max), and the result is compared with the metric range of the policy. If the results are still within range for all metrics of the policy, the NwSlices in the group can be merged. If any of the aggregate values out of range for any metric of the policy, the group is split into two or more sub-groups so that each sub-group satisfies this criterion, step 806, i.e. all aggregate values are within the metric ranges of the policy. If a NwSlice does not specify any value for a metric, it can be assumed that it requires the default value (e.g. minValue) specified for the metric in the policy, so this value can be used in the aggregation. Other defaults can be used as well.

After processing the generated combinations of NwSlices according to the above criteria, each combination represents a possible solution for the user intent expressed by the NSliceReq that satisfies the operator's intents represented by the grouping policies. Accordingly, from the SM model created in the workflow of FIG. 6 (i.e. input SM) multiple SM models can be derived—one for each possible combination of the NwSlices, step 807. To do so, for NwSlices that are matched to a policy by themselves (either because no other was matched to the same policy or because merging was not allowed), all the elements from the input SM are copied to the derived SM while keeping in the MatchedPolicies attribute the policy selected for each NwSlice by the given combination. For example, for our example combination Comb2 the derived SM will include NwS1 with the MatchedPolicies attribute set to Policy2 and NwS2 with the MatchedPolicies attribute set to Policy1.

For NwSlices that form a group in a combination because they can be merged, the NwSlice elements of the input SM are transformed into a single merged-NwSlice element, for which the MatchedPolicies attribute is set to the matched policy of the group in the combination. For NwSlices that were requested by the user intent (NSliceReq) as transport slices, and which are merged with others, the names of the requested transport slices are kept in the originTransportSlice attribute of the merged-NwSlice. The PolicyDeploymentOptions attribute of the merged-NwSlice is set according to the deployment options of the matched policy (if any).

The associations of each NwSlice of the input SM are transformed into associations of the merged-NwSlice element. Elements defined with a context (e.g. placement constraints, decomposition) referring to one of the NwSlices in the input SM are reset to refer to the merged-NwSlice.

Some NwSlice elements in the generated SMs may not have all associated QoS intent elements for all metric ranges of their matched policies. To guarantee that they will satisfy their matched policies, these missing QoS intent elements are set based on the matched policy. If the NwSlice did not result from a merging, the QoS intent elements are set to the default (e.g. minValue) of the metric ranges of the matched policy. If the NwSlice resulted from a merging, the QoS intent elements are set to the aggregate value for each metrics (as describe at the third criterion), where for each missing metrics the default (e.g. the minValue) value of the policy is used.

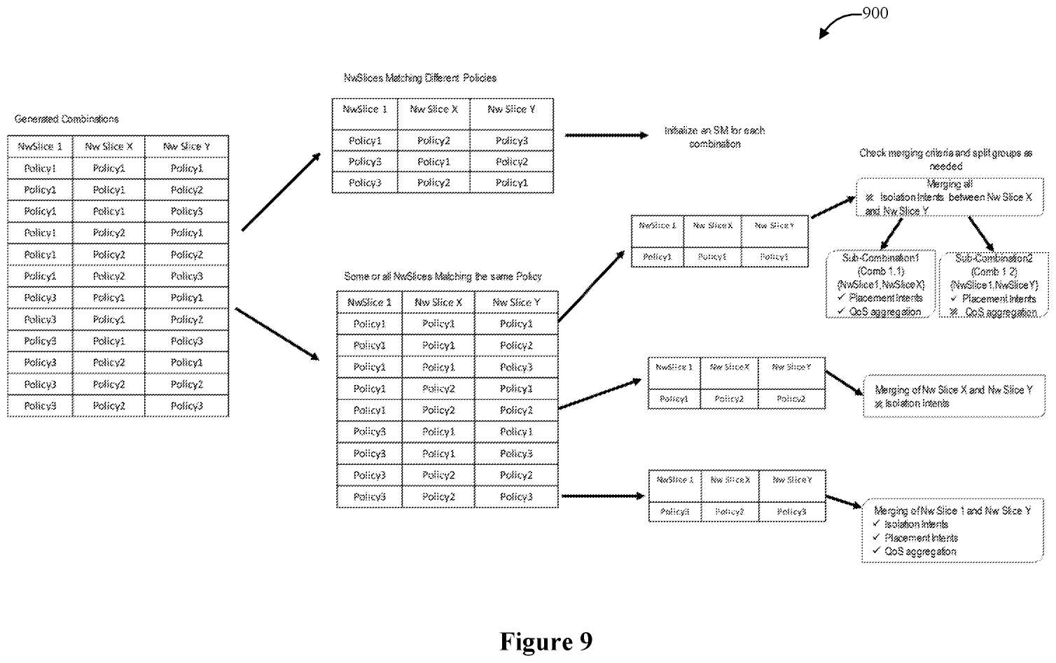

FIG. 9 illustrates an example result 900 of the flowchart of FIG. 8, where the SM generated in the example of FIG. 7 is used as a starting point. First, all possible combinations of policy matching are generated. The resulting combinations are shown in the first table of FIG. 9.

Combinations, where no two NwSlices have a common matched policy require no further processing. In this example, there are three such combinations shown in the top table of FIG. 9 where NwSlice1, NwSliceX and NwSliceY are all matched to different policies. This means that these NwSlices are not merged for these combinations and require no further processing in this respect. For each of these combinations an SM can be generated.

The bottom table of FIG. 9 shows combinations where some or all NwSlices have common policies. This means that these groups of NwSlices might be merged into single NwSlices.

The merging criteria checking is first explained on the example of NwSlice1 and NwSliceY, both of which were matched to Policy3 in the last row of the table. Neither NwSlices have an isolation intent with respect to the other nor contradicting placement constraints. To calculate the QoS aggregation of NwSlice1 and NwSliceY, each metric and their aggregation relation defined in Policy3 are checked. Policy3 defines the metric range of dataRateUL, while neither NwSlice1 nor NwSliceY has a QoS intent with this metric. In this case, as default the minValue of Policy3 can be used for each NwSlice (i.e. 10 Mbps). The aggregation relation defined by Policy3 for this metric is summation, hence for the two NwSlices the needed aggregate is 20 Mbps for the dataRateUL metric. The maximum allowed value for this metric is 30 Mbps, hence the aggregated QoS value is still within range for Policy3.

The rest of the metrics defined in Policy3 are checked similarly. In this case, the QoS aggregation for all metrics remain within range for Policy3, consequently NwSice1 and NwSliceY can be merged into a single merged-NwSlice element for this combination.

To take another example of checking the merging criteria, the first row of the bottom table shows the combination in which all NwSlices are matched with Policy1. When checking the isolation intents, NwSliceY requires a logical isolation from NwSliceX at the slice level, hence they cannot be merged. Therefore, according to the isolation intent criterion, they need to be placed into different sub-groups. This can be achieved in two ways resulting in two combinations:
Comb1.1: {group1.1: {NwSlice1, NwSliceX}, group1.2: {NwSliceY}}
Comb 1.2: {group1.1: {NwSlice1, NwSliceY}, group1.2: {NwSliceX}}

Both of these combinations are checked against the remaining merging criteria.

For Comb1.1, NwSlice1 and NwSliceX are checked against the second criterion (placement intent). They do not have any contradiction in this respect, therefore they are also checked for the aggregation of their QoS intents. Policy1 specifies a metric range for dataRateDL. NwSlice1 requires 25 Mbps for this metric, while NwSliceX has no specific requirement. By considering for NwSliceX as default the minValue (20 Mbps) of Policy1, the aggregated QoS can be calculated as 45 Mbps, which is still within range for Policy1. Similar check can be performed for the rest of the metrics and for these two NwSlices all aggregated QoS values remain in range for Policy1, therefore the two NwSlices can be merged for this combination.

For Comb 1.2, while checking the QoS aggregations of NwSlice1 and NwSliceY, it is determined that the aggregation of their dataRateDL results in 75 Mbps, which is out of range for Policy1, which has maxValue: 60 Mbps. Hence, these NwSlices cannot be merged and the group is split further. This results in a combination where each NwSlices is in a separate group, i.e. Comb1.2: {group1.1.1: {NwSlice1}, group1.1.2: {NwSliceY}, group1.2: {NwSliceX}}. Thus, no further merging is possible.

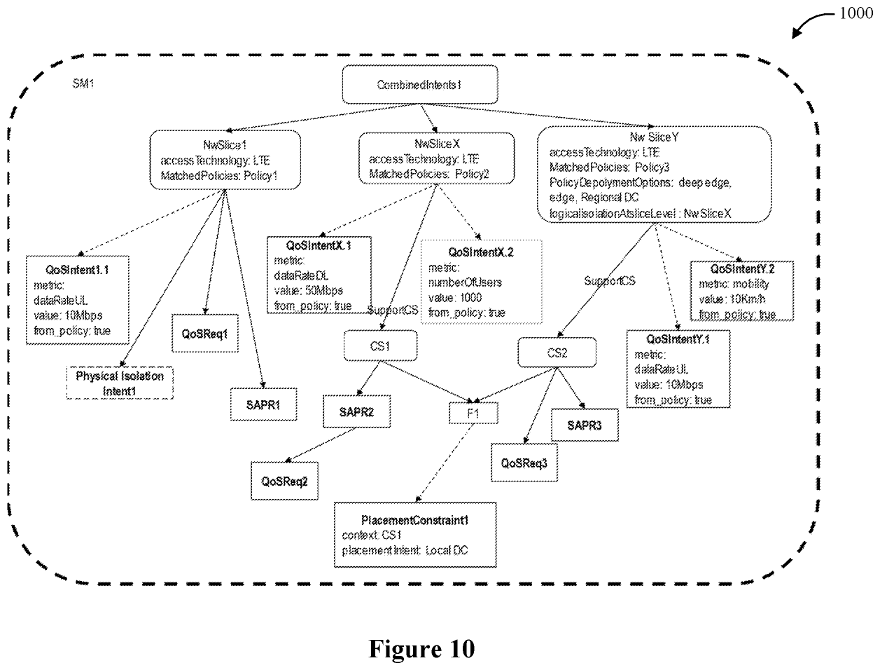

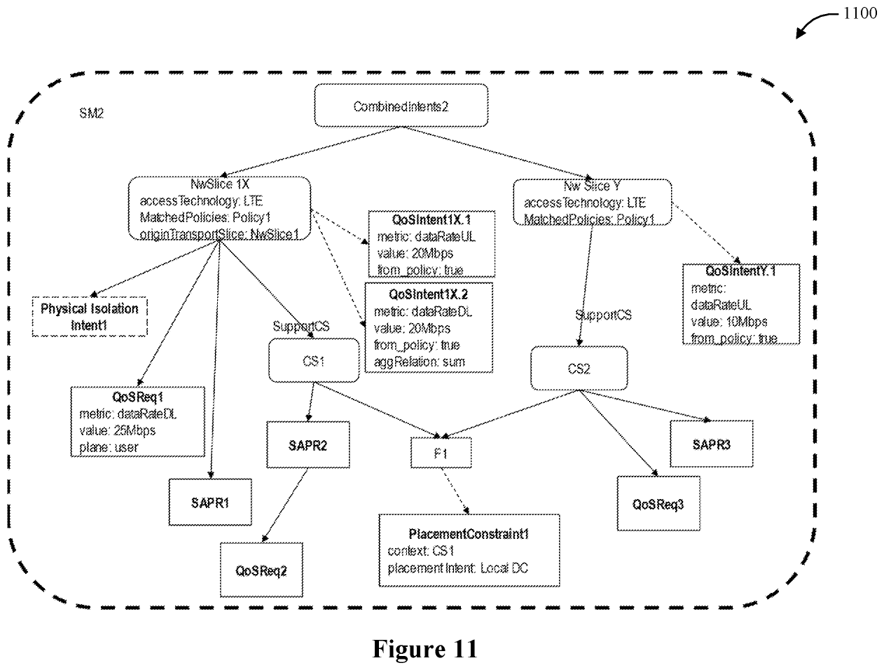

For each resulting combination an SM is created. As examples, two of the generated SMs 1000 and 1100 are shown in FIGS. 10 and 11 respectively.

SM1 of FIG. 10 is generated from the combination {NwSlice1: Policy1, NwSliceX: Policy2, NwSliceY: Policy3} of the first row of the top table of FIG. 9. In this case, no merging is performed, and NwSlice elements of FIG. 7 are copied with their associated elements to SM1 of FIG. 10, with the exception of the MatchedPolicies attribute for which only the selected policy is copied for each NwSlice. In addition, any missing QoS intent of any NwSlice is set based on the default for the metric of the matched policy. For instance, NwSlice1 does not have a QoS intent for dataRateUL, while Policy1 defines a metric range for it. Hence, in the SM1 a QoS intent element is created for NwSlice1 for the dataRateUL metric and set to the default, in this case the minValue of Policy1 for the metric.

In the example illustrated in FIG. 11, SM2 is generated from the combination Comb1.1: {{NwSlice1, NwSliceX}: Policy1, NwSliceY: Policy1}. In this combination, NwSlice1 and NwSliceX are merged together, therefore, they are transformed into a merged-NwSlice element, namely NwSlice1X. It is matched to Policy1 according to Comb1.1.

NwSlice1X represents the merging of transport NwSlice1 and a NwSlice created to support CS1. Since transport NwSlices are part of the functional requirements the originTransportSlice attribute of NwSlice1X is set to NwSlice1. Afterwards, all the elements associated with NwSlice1 and NwSliceX in the input SM of FIG. 7, are created in SM2 and associated with NwSlice1X. In this example, there is no context referring to NwSlice1 or NwSliceX, so no context update is needed. Otherwise, a new context would need to be created referencing NwSlice1X. The second NwSlice created in SM2 for combination Comb1.1 is NwSliceY, which is copied with its associated elements from the input SM, but its MatchedPolicies attribute is set to Policy1 only.

SM2 is finalized by setting any missing QoS intent for any NwSlice from Policy1. None of the NwSlices have a QoS intent for dataRateUL, while Policy1 defines such a metric. Therefore, for NwSliceY a QoS intent, i.e. QoSIntentY.1, is created with the value set to 10 Mbps according to the minValue for the metric in Policy1 and associated to NwSliceY. Similarly, a QoS intent element, i.e. QoSIntent1X.1, is created for NwSlice1X for this metric. Its value is set to 20 Mbps, which is the aggregation for the two merged NwSlices considering the default value for each (i.e. the minValue of Policy1 for the metric). Policy1 also defines the dataRateDL metric. NwSlice1 has a QoS intent for this metric for the user plane (QoSReq1) while NwSliceX does not. Since the metric range defined in the policy for this metric does not specify the plane, the aggregation of QoSReq1 with the policy default may not be appropriate. Instead, a new QoS Intent element is created, i.e. QoSlntent1X.2, which is set as the default to the minValue specified in the metric range (20 Mbps) of Policy1.

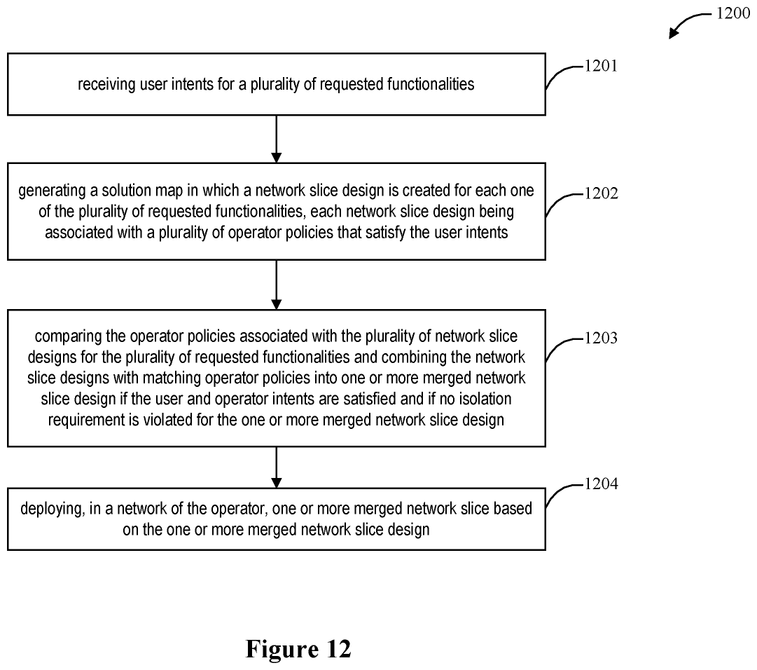

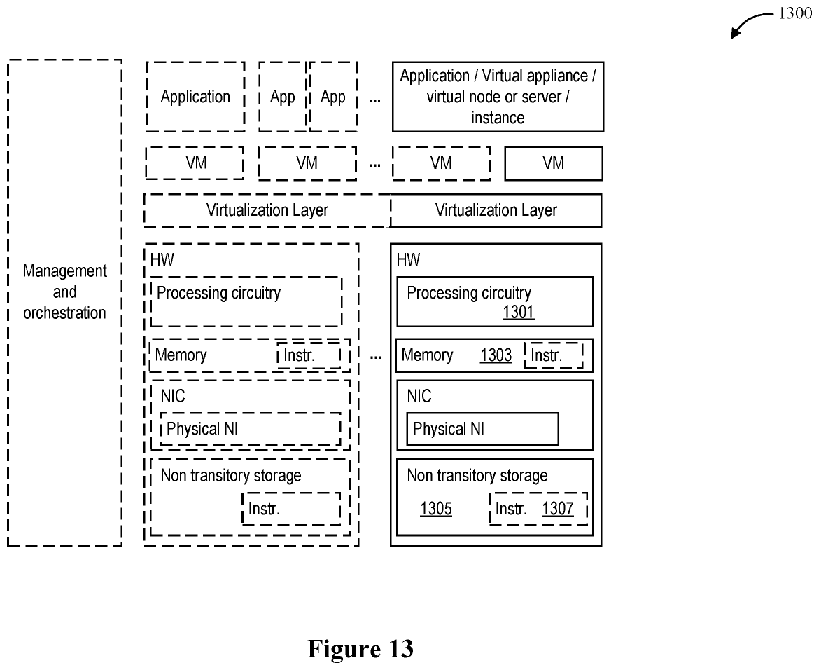

FIG. 12 illustrates a method 1200 for combining user and operator intents in network slice design and deployment. The method comprises receiving, step 1201, user intents for a plurality of requested functionalities. The method comprises generating, step 1202, a solution map in which a network slice design is created for each one of the plurality of requested functionalities, each network slice design being associated with a plurality of operator policies that satisfy the user intents. The method comprises comparing, step 1203, the operator policies associated with the plurality of network slice designs for the plurality of requested functionalities and combining the network slice designs with matching operator policies into one or more merged network slice design if the user and operator intents are satisfied and if no isolation requirement is violated for the one or more merged network slice design. The method comprises deploying, step 1204, in a network of the operator, one or more merged network slice based on the one or more merged network slice design.

As explained in more details previously, the requested functionalities may comprise communication services, network slices or a mix thereof. The user intents may comprise quality of service and isolation requirements for each of the requested functionalities. The operator intents may comprise the operator policies, which specify supported quality of service ranges for available communications services and network slices.

The method may further comprise, prior to generating a solution map, for each of the requested functionality, selecting the operator policies that match the isolation requirements for the requested functionality, and selecting communications services and network slices for which the quality of service ranges of the selected operator policies match the quality of service for the requested functionality.

The method may further comprise, prior to comparing, generating, from the solution map, all possible combinations of operator policies and network slice designs.

Combining the network slice designs with matching operator policies into one or more merged network slice design if the user and operator intents are satisfied and if no isolation requirement is violated for the one or more merged network slice design may further comprise placing network slice designs that require isolation from one another in separate merged network slice designs.

Combining the network slice designs with matching operator policies into one or more merged network slice design if the user and operator intents are satisfied and if no isolation requirement is violated for the one or more merged network slice design may further comprise comparing an aggregated quality of service for the merged network slice design with supported quality of service ranges defined by corresponding operator policies.

Combining the network slice designs with matching operator policies into one or more merged network slice design if the user and operator intents are satisfied and if no isolation requirement is violated for the one or more merged network slice design may further comprise combining the network slice designs if at least a first and a second of the network slice designs have a common functionality element.

Referring to FIG. 13, there is provided a virtualization environment 1300 in which functions and steps described herein can be implemented.

A virtualization environment (which may go beyond what is illustrated in FIG. 13), may comprise systems, networks, servers, nodes, devices, etc., that are in communication with each other either through wire or wirelessly. Some or all of the functions and steps described herein may be implemented as one or more virtual components (e.g., via one or more applications, components, functions, virtual machines or containers, etc.) executing on one or more physical apparatus in one or more networks, systems, environment, etc.

A virtualization environment provides hardware comprising processing circuitry 1301 and memory 1303. The memory can contain instructions executable by the processing circuitry whereby functions and steps described herein may be executed to provide any of the relevant features and benefits disclosed herein.

The hardware may also include non-transitory, persistent, machine readable storage media 1305 having stored therein software and/or instruction 1307 executable by processing circuitry to execute functions and steps described herein.

Still referring to FIG. 13, there is provided an apparatus (HW in FIG. 13) operative to combine user and operator intents in network slice design and deployment. The apparatus comprises processing circuits 1301 and a memory 1303, 1305. The memory 1303, 1305 contains instructions executable by the processing circuits whereby the apparatus is operative to receive user intents for a plurality of requested functionalities. The apparatus is operative to generate a solution map in which a network slice design is created for each one of the plurality of requested functionalities, each network slice design being associated with a plurality of operator policies that satisfy the user intents. The apparatus is operative to compare the operator policies associated with the plurality of network slice designs for the plurality of requested functionalities and combine the network slice designs with matching operator policies into one or more merged network slice design if the user and operator intents are satisfied and if no isolation requirement is violated for the one or more merged network slice design. The apparatus is operative to deploy, in a network of the operator, one or more merged network slice based on the one or more merged network slice design.

The requested functionalities may comprise communication services, network slices or a mix thereof. The user intents may comprise quality of service and isolation requirements for each of the requested functionalities. The operator intents may comprise the operator policies, which specify supported quality of service ranges for available communications services and network slices.

The apparatus is further operative to, prior to generate a solution map, for each of the requested functionality select the operator policies that match the isolation requirements for the requested functionality, and select communications services and network slices for which the quality of service ranges of the selected operator policies match the quality of service for the requested functionality.

The apparatus is further operative to, prior to compare, generate, from the solution map, all possible combinations of operator policies and network slice designs.

Combine the network slice designs with matching operator policies into one or more merged network slice design if the user and operator intents are satisfied and if no isolation requirement is violated for the one or more merged network slice design may comprise place network slice designs that require isolation from one another in separate merged network slice designs.

Combine the network slice designs with matching operator policies into one or more merged network slice design if the user and operator intents are satisfied and if no isolation requirement is violated for the one or more merged network slice design may comprise compare an aggregated quality of service for the merged network slice design with supported quality of service ranges defined by corresponding operator policies.

Combine the network slice designs with matching operator policies into one or more merged network slice design if the user and operator intents are satisfied and if no isolation requirement is violated for the one or more merged network slice design may comprise combine the network slice designs if at least a first and a second of the network slice designs have a common functionality element.

Still referring to FIG. 13, there is provided a non-transitory computer readable media 1305 having stored thereon instructions for combining user and operator intents in network slice design and deployment. The instructions comprise receiving user intents for a plurality of requested functionalities. The instructions comprise generating a solution map in which a network slice design is created for each one of the plurality of requested functionalities, each network slice design being associated with a plurality of operator policies that satisfy the user intents. The instructions comprise comparing the operator policies associated with the plurality of network slice designs for the plurality of requested functionalities and combining the network slice designs with matching operator policies into one or more merged network slice design if the user and operator intents are satisfied and if no isolation requirement is violated for the one or more merged network slice design. The instructions comprise deploying, in a network of the operator, one or more merged network slice based on the one or more merged network slice design.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A method for combining user and operator intents in network slice design and deployment, comprising:
receiving user intents for a plurality of requested functionalities;
generating a solution map in which a network slice design is created for each one of the plurality of requested functionalities, each network slice design being associated with a plurality of operator policies that satisfy the user intents;
comparing the operator policies associated with the plurality of network slice designs for the plurality of requested functionalities and combining the network slice designs with matching operator policies into one or more merged network slice design if the user and operator intents are satisfied and if no isolation requirement is violated for the one or more merged network slice design; and
deploying, in a network of the operator, one or more merged network slice based on the one or more merged network slice design.

2. The method of claim 1, wherein the requested functionalities comprise communication services, network slices or a mix thereof.

3. The method of claim 2, wherein the user intents comprise quality of service and isolation requirements for each of the requested functionalities.

4. The method of claim 3, wherein the operator intents comprise the operator policies, which specify supported quality of service ranges for available communications services and network slices.

5. The method of claim 4, further comprising, prior to generating a solution map, for each of the requested functionality:
selecting the operator policies that match the isolation requirements for the requested functionality, and
selecting communications services and network slices for which the quality of service ranges of the selected operator policies match the quality of service for the requested functionality.

6. The method of claim 1, further comprising, prior to comparing, generating, from the solution map, all possible combinations of operator policies and network slice designs.

7. The method of claim 1, wherein combining the network slice designs with matching operator policies into one or more merged network slice design if the user and operator intents are satisfied and if no isolation requirement is violated for the one or more merged network slice design comprises:
placing network slice designs that require isolation from one another in separate merged network slice designs.

8. The method of claim 1, wherein combining the network slice designs with matching operator policies into one or more merged network slice design if the user and operator intents are satisfied and if no isolation requirement is violated for the one or more merged network slice design comprises:
comparing an aggregated quality of service for the merged network slice design with supported quality of service ranges defined by corresponding operator policies.

9. The method of claim 1, wherein combining the network slice designs with matching operator policies into one or more merged network slice design if the user and operator intents are satisfied and if no isolation requirement is violated for the one or more merged network slice design comprises:
combining the network slice designs if at least a first and a second of the network slice designs have a common functionality element.

10. An apparatus operative to combine user and operator intents in network slice design and deployment comprising processing circuits and a memory, the memory containing instructions executable by the processing circuits whereby the apparatus is operative to:
receive user intents for a plurality of requested functionalities;
generate a solution map in which a network slice design is created for each one of the plurality of requested functionalities, each network slice design being associated with a plurality of operator policies that satisfy the user intents;
compare the operator policies associated with the plurality of network slice designs for the plurality of requested functionalities and combine the network slice designs with matching operator policies into one or more merged network slice design if the user and operator intents are satisfied and if no isolation requirement is violated for the one or more merged network slice design; and
deploy, in a network of the operator, one or more merged network slice based on the one or more merged network slice design.

11. The apparatus of claim 10, wherein the requested functionalities comprise communication services, network slices or a mix thereof.

12. The apparatus of claim 11, wherein the user intents comprise quality of service and isolation requirements for each of the requested functionalities.

13. The apparatus of claim 12, wherein the operator intents comprise the operator policies, which specify supported quality of service ranges for available communications services and network slices.

14. The apparatus of claim 13, further operative to, prior to generate a solution map, for each of the requested functionality:
select the operator policies that match the isolation requirements for the requested functionality, and
select communications services and network slices for which the quality of service ranges of the selected operator policies match the quality of service for the requested functionality.

15. The apparatus of claim 10, further operative to, prior to compare, generate, from the solution map, all possible combinations of operator policies and network slice designs.

16. The apparatus of claim 10, wherein combine the network slice designs with matching operator policies into one or more merged network slice design if the user and operator intents are satisfied and if no isolation requirement is violated for the one or more merged network slice design comprises:
place network slice designs that require isolation from one another in separate merged network slice designs.

17. The apparatus of claim 10, wherein combine the network slice designs with matching operator policies into one or more merged network slice design if the user and operator intents are satisfied and if no isolation requirement is violated for the one or more merged network slice design comprises:
compare an aggregated quality of service for the merged network slice design with supported quality of service ranges defined by corresponding operator policies.

18. The apparatus of claim 10, wherein combine the network slice designs with matching operator policies into one or more merged network slice design if the user and operator intents are satisfied and if no isolation requirement is violated for the one or more merged network slice design comprises:
combine the network slice designs if at least a first and a second of the network slice designs have a common functionality element.

19. A non-transitory computer readable media having stored thereon instructions for combining user and operator intents in network slice design and deployment, the instructions comprising:
receiving user intents for a plurality of requested functionalities;
generating a solution map in which a network slice design is created for each one of the plurality of requested functionalities, each network slice design being associated with a plurality of operator policies that satisfy the user intents;
comparing the operator policies associated with the plurality of network slice designs for the plurality of requested functionalities and combining the network slice designs with matching operator policies into one or more merged network slice design if the user and operator intents are satisfied and if no isolation requirement is violated for the one or more merged network slice design; and
deploying, in a network of the operator, one or more merged network slice based on the one or more merged network slice design.
